(19) United States
(12) Patent Application Publication
(10) Pub. No.: US 2020/0283070 A1
(43) Pub. Date: Sep. 10, 2020

(54) VEHICLE RIGIDLY APPARATUS FOR USE WITH VEHICLES

(71) Applicant: AISIN TECHNICAL CENTER OF AMERICA, INC., Northville, MI (US)

(72) Inventor: Kamin MANATPON, Ann Arbor, MI (US)

(73) Assignee: AISIN TECHNICAL CENTER OF AMERICA, INC., Northville, MI (US)

(21) Appl. No.: 16/297,418

(22) Filed: Mar. 8, 2019

(51) Int. Cl. B62D 25/06; B62D 27/06

(52) U.S. Cl. CPC B62D 25/06; B62D 27/06

(57) ABSTRACT

Vehicle rigidity apparatus for a vehicle are disclosed. A disclosed the vehicle rigidity apparatus for a central frame that extends in a lateral direction of the vehicle and lateral frames that extend in a front-rear direction of the vehicle and intersect the central frame. The vehicle rigidity apparatus also includes a reinforced bar that extends in the lateral direction of the vehicle supported by the lateral frames, the reinforced bar being movable from a position at the central frame toward a front of the vehicle in the front-rear direction and a movable portion at the central frame that moves the reinforced bar toward the front of the vehicle. The movable portion moves the reinforced bar toward the front of the vehicle to a position separated from the central frame.

### FIELD OF THE DISCLOSURE

This disclosure relates generally to vehicles and, more particularly, to vehicle rigidly apparatus for use with vehicles.

### BACKGROUND

Motor vehicles having panoramic-windshield typically employ vehicle rigidly system to increase the rigidly of the vehicle. Some vehicles are reducing frames in the vehicle to ensure the passenger's field of view. On the other hand, the vehicle is required to have sufficient rigidity.

### SUMMARY

An example vehicle rigidly apparatus for a vehicle includes a central frame that extends in a lateral direction of the vehicle and lateral frames that extend in a front-rear direction of the vehicle and intersect the central frame. The vehicle rigidity apparatus also includes a reinforced bar that extends in the lateral direction of the vehicle supported by the lateral frames, the reinforced bar being movable from a position at the central frame toward a front of the vehicle in the front-rear direction and a movable portion at the central frame that moves the reinforced bar toward the front of the vehicle. The movable portion moves the reinforced bar toward the front of the vehicle to a position separated from the central frame.

The foregoing paragraphs have been provided by way of general introduction and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a view of an example vehicle in which examples disclosed herein can be implemented;

FIG. 2 is a block diagram of the example vehicle rigidly apparatus of FIG. 1.

FIG. 3 is a detailed view of an example guide portion from the position A to the portion B;

FIG. 4A is a detailed view of an example movable portion of vehicle rigidly apparatus at position A in accordance with the teachings of this disclosure;

FIG. 4B is a detailed view of an example movable portion of vehicle rigidly apparatus at position B in accordance with the teachings of this disclosure;

The figures are not to scale. In general, the same reference numbers will be used throughout the drawing(s) and accompanying written description to refer to the same or like parts.

### DETAILED DESCRIPTION

Some known vehicle rigidly apparatus for a panoramic windshield of a vehicle. In recent years, the shape of the windshield changes according to the change in the shape of the vehicle, and the vehicle rigidly system is expected to increase the rigidity of the vehicle. To increase the rigidity of the vehicle, some known vehicle rigidly apparatuses have the method for increasing the rigidity of the vehicle with reinforce parts.

For example, a vehicle rigidly apparatus of U.S. Pat. No. 2,868,373 has is provided with a strut that is retractable either in a cab interior structure or in a lower part of the vehicle. Further, the strut includes a deployment unit and is actuated by a detection unit in the event of an impact or loss of control of the vehicle for reinforcing the cab interior structure by deploying the strut. However, there is a problem that it is not possible to sufficiently obtain the vehicle rigidity in the width direction of the vehicle. Since the structure of panoramic-windshield has low vehicle rigidity in the longitudinal direction of the vehicle, the strut had to improve the vehicle rigidity in the longitudinal direction of the vehicle. In addition, since the strut is a method for increasing the rigidity of the vehicle using the surface, the view of the driver is impossible to be sufficiently secured.

Vehicle rigidly apparatus for a vehicle windshield is disclosed. Examples disclosed herein provide an example vehicle rigidly apparatus that is configured a central frame that extends in a lateral direction of the vehicle and lateral frames that extend in a front-rear direction of the vehicle and intersect the central frame. The vehicle rigidity apparatus also includes a reinforced bar that extends in the lateral direction of the vehicle supported by the lateral frames, the reinforced bar being movable from a position at the central frame toward a front of the vehicle in the front-rear direction and a movable portion at the central frame that moves the reinforced bar toward the front of the vehicle. The movable portion moves the reinforced bar toward the front of the vehicle to a position separated from the central frame. As a result, the vehicle rigidly apparatus is enabled to be sufficiently secured the view of the driver (or occupants) and is possible to sufficiently obtain the vehicle rigidity of the vehicle.

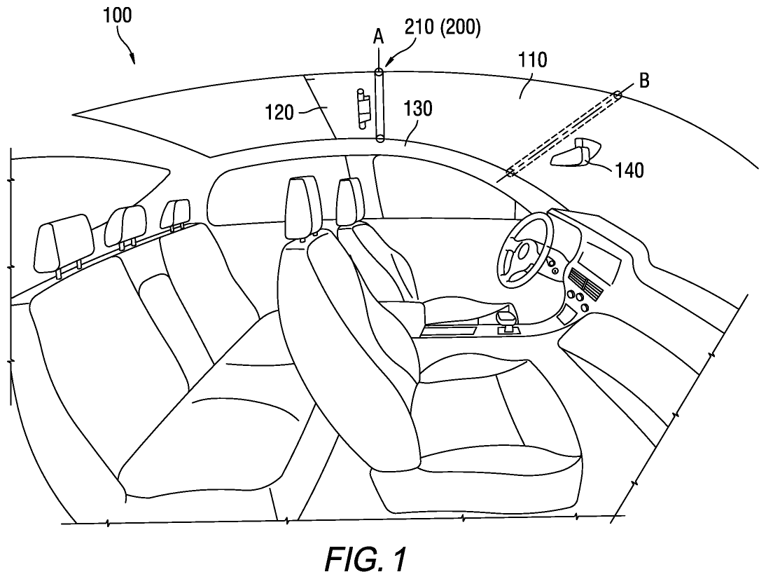

FIG. 1 is a view of an example vehicle (e.g., a car, a van, a truck, a sport utility vehicle (SUV), etc.) 100 in which examples disclosed herein can be implemented. According to the illustrated example of FIG. 1, the vehicle 100 includes a panoramic windshield 110 and that are mounted between a central frame 120 and lateral frames 130. The central frame 120 extends in a lateral direction of the vehicle 100 and the lateral frames 130 extend in a front-rear direction of the vehicle and intersect the central frame 120. Further, in some examples, the vehicle 100 also includes a vehicle rigidly apparatus 200 to reinforce to reinforce the rigidly of the vehicle 100. The vehicle rigidly apparatus 200 includes the central frame 120, lateral frames 130 and a reinforced bar 210 that extends in the lateral direction of the vehicle 100 supported by the lateral frames 130. The reinforced bar 210 is movable from a position at the central frame 120 toward a front of the vehicle 100 in the front-rear direction. The reinforced bar 210 is housed in the center frame 120 before being movable. Then, the reinforced bar 210 moves from position A at the central frame 120 to a position B of the front of the vehicle 100. Accordingly, the reinforced bar 210 moves toward the front of the vehicle 100 to a position separated from the central frame 120. Therefore, the vehicle 100 with panoramic-windshield has a frame structure similar to that of a normal vehicle and can improve the rigidity of the vehicle 100.

Although FIG. 1 depicts the vehicle rigidly apparatus 200 for reinforcing the vehicle that provides the panoramic windshield 110, in some example, the vehicle rigidly apparatus 200 is implemented using for reinforcing the vehicle that provides a general windshield.

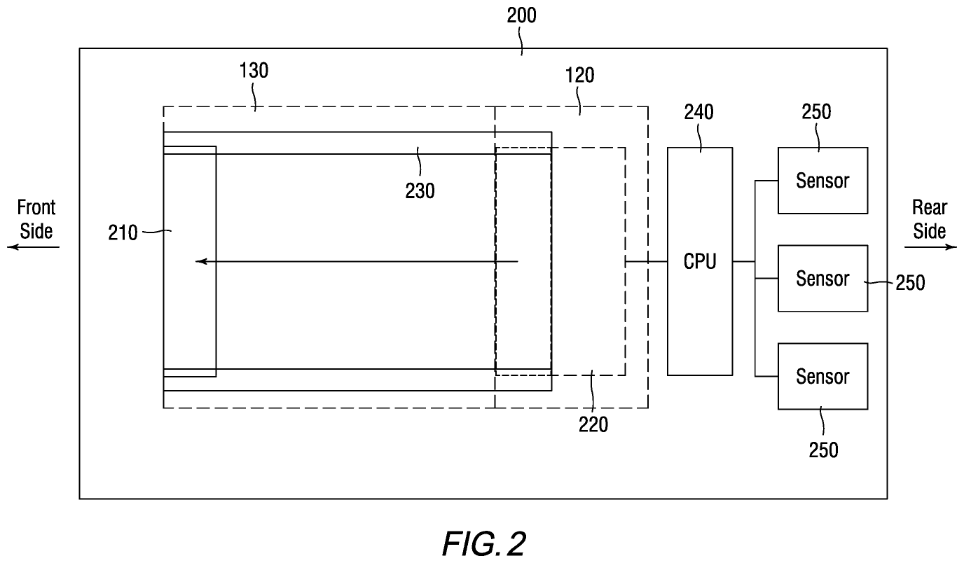

FIG. 2 is a block diagram of the vehicle rigidly apparatus 200 of FIG. 1. As shown in FIG. 2, the vehicle rigidly apparatus 200 includes the central frame 120, lateral frames 130 and the reinforced bar 210. Further, in some examples, the vehicle rigidly apparatus 200 also includes a movable portion 220 at the central frame 120 to move the reinforced bar 210 toward the front of the vehicle 100. In addition, the movable portion 220 moves the reinforced bar 210 toward the front of the vehicle to a position separated from the central frame 120. The lateral frames 130 include a guide 230 extended in the front-rear direction of the vehicle 100, and the reinforced bar 210 moves toward the front of the vehicle along the guide 230. Further, the vehicle rigidly apparatus 200 also includes a microcomputer 240, and some sensors 250 to detect the state of the vehicle 100.

As shown in FIG. 2, when the sensor 250 detects that the state of the vehicle 100 has changed (e.g., when a strong shock is applied to the vehicle or when the vehicle suddenly changes its angle, etc.), (i.e., an abnormal state), the microcomputer 240 catch the signal from the sensor 250. Then, the microcomputer 240 send the signal for drive to the movable portion 220. Accordingly, the reinforced bar 210 is able to move toward the front of the vehicle 100.

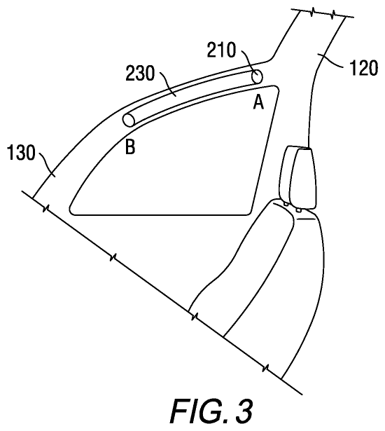

FIG. 3 is a detailed view of an example guide portion from the position A to the portion B. The reinforced bar 210 of the vehicle rigidly apparatus 200 moves from the position A to the portion and among the guide 230 of the lateral frames 130. The position A is set in or near the central frame 120. The position B is set in front of the vehicle 100 away from the central frame 130. A distance that is from the position A to the position B and the material of the reinforced bar 210 are determined so as to satisfy the required vehicle rigidity on the basis of the structure of the vehicle 100. For example, the reinforced bar 210 is configured to provide a strength-to-weight ratio of about 4.00 with vehicle frames when deployed.

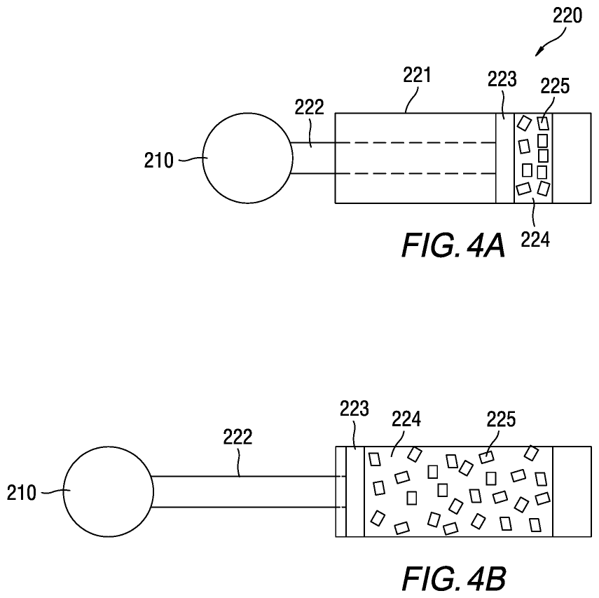

FIG. 4A is a detailed view of an example movable portion of vehicle rigidly apparatus at position A in accordance with the teachings of this disclosure. The movable portion 220 is a cylinder 221. The cylinder 221 includes a cylinder rod 222 to be mounted the reinforced bar 210 on the front end, and a rod head 223 to move in the cylinder 221, and a cylinder chamber 224 formed by the cylinder 221 and the rod head 223, and inflow or expansion materials 225 (i.e., materials or structure that can press the rod head 223 in the cylinder chamber 224) to push the cylinder rod 22 via the rod head 223 and filled up in the cylinder chamber 224. Accordingly, the reinforced bar 210 keeps position A before sensors 250 detect the state of the vehicle 100 and the microcomputer 240 determines that the vehicle 100 is in the abnormal state.

FIG. 4B is a detailed view of an example movable portion of vehicle rigidly apparatus at position B in accordance with the teachings of this disclosure. For example, it is assumed that it is air. When the microcomputer 240 determines the abnormal state based on the signal from sensor 250, materials 225 are filled up in the cylinder chamber 224. Then, the materials 225 push the road head 223 and the cylinder road 222 moves toward the front direction of the vehicle 100. Therefore, the reinforced bar 210 is pushed forward of the vehicle and can move from position A to position B.

It will be appreciated that a vehicle rigidly apparatus for use with vehicles disclosed in the foregoing description provide numerous advantages. Examples disclosed herein provide a vehicle rigidly apparatus including a reinforced bar and a movable portion provided on vehicle frames. Disclosed examples effectively increase the rigidly of the vehicle while maintaining effectiveness of the panoramic windshield.

Although certain example apparatus has been disclosed herein, the scope of coverage of this patent is not limited thereto. Obviously, numerous modifications and variations are possible in light of the above teachings. It is therefore to be understood that within the scope of the appended claims, the invention may be practiced otherwise than as specifically described herein.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

What is claimed is:

1. A vehicle rigidity apparatus for a vehicle, comprising:
a central frame that extends in a lateral direction of the vehicle;
lateral frames that extend in a front-rear direction of the vehicle and intersect the central frame;
a reinforced bar that extends in the lateral direction of the vehicle supported by the lateral frames, the reinforced bar being movable from a position at the central frame toward a front of the vehicle in the front-rear direction; and
a movable portion at the central frame that moves the reinforced bar toward the front of the vehicle,
wherein the movable portion moves the reinforced bar toward the front of the vehicle to a position separated from the central frame.

2. The vehicle rigidly apparatus of claim 1, wherein;
the lateral frames include a guide extended in the front-rear direction of the vehicle, and the reinforced bar moves toward the front of the vehicle along the guide.

3. The vehicle rigidly apparatus of claim 1, wherein the movable portion is a cylinder configured to push the reinforced bar toward the front of the vehicle.
